(19) United States
(12) Patent Application Publication
(10) Pub. No.: US 2025/0282158 A1
(43) Pub. Date: Sep. 11, 2025

(54) MEDIUM CONVEYANCE DEVICE AND RECORDING DEVICE

(71) Applicant: SEIKO EPSON CORPORATION, Tokyo (JP)

(72) Inventors: Ryota HARA, MATSUMOTO-SHI (JP); Shunta OIKAWA, MATSUMOTO-SHI (JP)

(21) Appl. No.: 19/070,945

(22) Filed: Mar. 5, 2025

(30) Foreign Application Priority Data
Mar. 8, 2024 (JP) 2024-035603

(51) Int. Cl. B41J 13/08; B41J 29/17

(52) U.S. Cl. CPC B41J 13/08; B41J 29/17

(57) ABSTRACT

A medium conveyance device includes a conveyance unit that includes a conveying belt that conveys a target recording medium at an opposing position facing a recording unit that performs recording, and a collection unit that is disposed vertically below the conveying belt at the opposing position and is configured to collect foreign matter that has fallen off the conveying belt, in which the conveying belt is configured to be movable between the opposing position and a retracted position that is a position different from the opposing position, and the collection unit moves in association with a movement of the conveying belt.

The present application is based on, and claims priority from JP Application Serial Number 2024-035603, filed Mar. 8, 2024, the disclosure of which is hereby incorporated by reference herein in its entirety.

### BACKGROUND

### 1. Technical Field

The present disclosure relates to a medium conveyance device and a recording device including the medium conveyance device.

### 2. Related Art

For example, JP-A-2018-65303 discloses a liquid ejection device that includes a conveying belt at a position facing a liquid ejection unit that performs recording on a medium, on a conveyance path for the medium that extends while curving from a storage cassette for media such as paper toward a holding tray. According to JP-A-2018-65303, the conveying belt is configured to be movable between an opposing position at which the medium is supported on the conveyance path and a retracted position away from the conveyance path, and when the conveying belt moves to the retracted position, a maintenance device performs maintenance operations such as suction cleaning and wiping of the liquid ejection unit.

When foreign matter such as paper dust adheres to such a conveying belt, there is a concern that a defect such as poor adhesion of the medium may occur. In particular, when paper dust scatters and adheres to the liquid ejection unit, there is a concern of a discharge nozzle becoming clogged, which requires a method of collecting foreign matter.

However, JP-A-2018-65303 does not include any description of a method of collecting foreign matter, which leaves room for improvement. For example, it is conceivable to provide a collection unit that collects foreign matter such as paper dust that falls under the conveying belt. However, if a collection unit is provided in a configuration in which the conveying belt is movable, it is necessary to provide the collection unit at a position away from a movement region of the conveying belt so as not to impede the movement of the conveying belt, resulting in the problem that foreign matter may scatter and cannot be collected efficiently. In other words, there has been a demand for a medium conveyance device, and a recording device, capable of efficiently collecting foreign matter in a configuration in which a conveying belt is movable.

### SUMMARY

A medium conveyance device according to one aspect of the present application includes a conveyance unit that includes a conveying belt that is configured to convey a target recording medium at an opposing position facing a recording unit that is configured to perform recording, and a collection unit that is disposed vertically below the conveying belt at the opposing position and is configured to collect foreign matter that has fallen off the conveying belt, in which the conveying belt is configured to be movable between the opposing position and a retracted position that is a position different from the opposing position, and the collection unit moves in association with a movement of the conveying belt.

A recording device according to one aspect of the present application includes a recording unit configured to perform recording on a target recording medium, and the medium conveyance device described above.

### BRIEF DESCRIPTION OF THE DRAWINGS

FIG. 1 is a schematic configuration diagram of a recording device according to a first embodiment.

FIG. 2 is a plan view of a liquid ejection unit and a maintenance unit.

FIG. 3 is a side cross-sectional view of main parts in one aspect of a medium conveyance device.

FIG. 4 is a side cross-sectional view of main parts in one aspect of the medium conveyance device.

FIG. 5 is a side cross-sectional view of main parts in one aspect of the medium conveyance device.

### DESCRIPTION OF EMBODIMENTS

### First Embodiment

### Overview of Recording Device

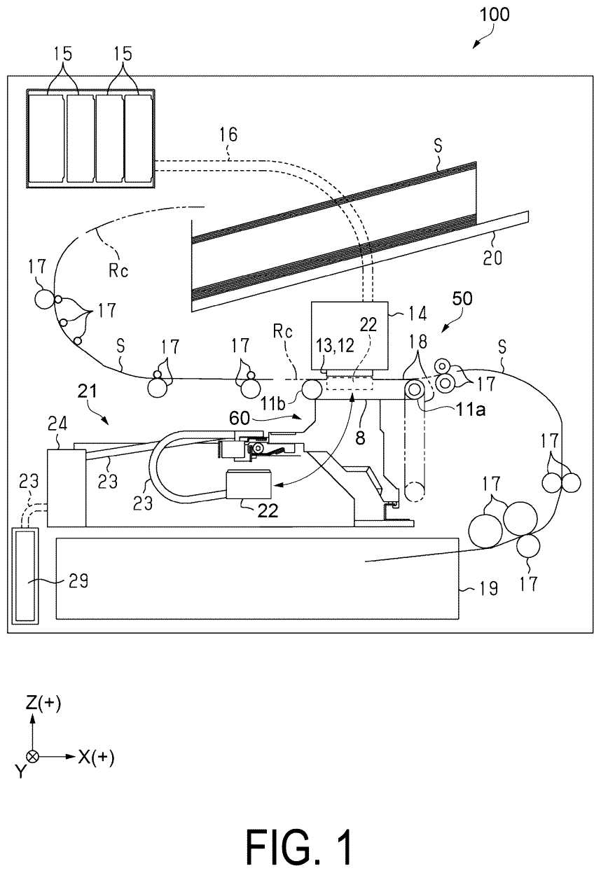

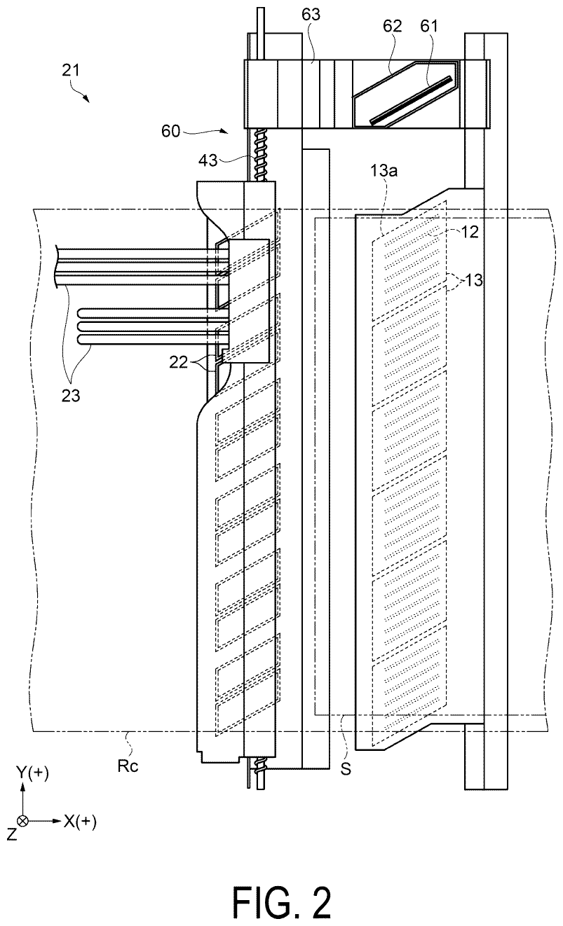

FIG. 1 is a schematic configuration diagram of a recording device according to a first embodiment. FIG. 2 is a plan view of a liquid ejection unit and a maintenance unit.

A recording device 100 of present embodiment is an inkjet printer configured to perform recording by ejecting a liquid onto a medium S such as paper. In a preferred example, the liquid is ink, and printing is performed on the medium S made of paper.

Each drawing shows three mutually orthogonal axes, that is, an X-axis, a Y-axis, and a Z-axis. In present embodiment, a direction in which the liquid is ejected from a liquid ejection unit 13 is a-Z direction. The-Z direction is a vertically downward direction. In addition, a direction along the X-axis is referred to as an “X direction”, a direction along the Y-axis is referred to as a “Y direction”, and a direction along the Z-axis is referred to as the “Z direction”. For example, the Y direction refers to both a +Y direction and a −Y direction. In addition, the +Z direction is referred to as “upward”, and the-Z direction is referred to as “downward”. Further, in the following drawings, dimensions and scales that are different from the actual ones may be used to make the description easier to understand.

The recording device 100 of present embodiment includes the liquid ejection unit 13 that ejects a liquid, a holding unit 14 that holds the liquid ejection unit 13, a supply flow path 16 for supplying a liquid from a liquid supply source 15 to the liquid ejection unit 13, a plurality of conveyance rollers 17 that convey the medium S, and the like. The liquid ejection unit 13 is a recording unit, and the position at which the liquid ejection unit 13 ejects a liquid is also referred to as a recording position.

The plurality of conveyance rollers 17 are disposed along a conveyance path Rc for the medium S that extends while curving from a storage cassette 19 on the lower side toward a holding tray 20 on the upper side. The storage cassette 19 side of the conveyance path Rc is also referred to as an upstream, and the holding tray 20 side is also referred to as a downstream.

The conveyance path Rc extends in the approximately horizontal X direction at the recording position, and the medium S is conveyed in the-X direction.

The recording device 100 further includes a medium conveyance device 50 including a conveyance unit 18 that supports the medium S at the recording position, and a maintenance unit 21 that performs maintenance of the liquid ejection unit 13 at the recording position. In other words, the recording device 100 includes the liquid ejection unit 13 serving as a recording unit that performs recording on the medium S serving as a target recording medium, and the medium conveyance device 50 including a conveyance unit 18. As shown in FIG. 1, during printing, the conveyance unit 18 is located at an opposing position facing the liquid ejection unit 13 on the conveyance path Rc. The opposing position is also a support position at which the medium S is supported.

The conveyance unit 18 includes a pair of rollers 11a and 11b, a conveying belt 8 stretched between the rollers 11a and 11b, and the like. In the conveyance path Rc, the roller 11ais located on the upstream, and the roller 11b is located on the downstream.

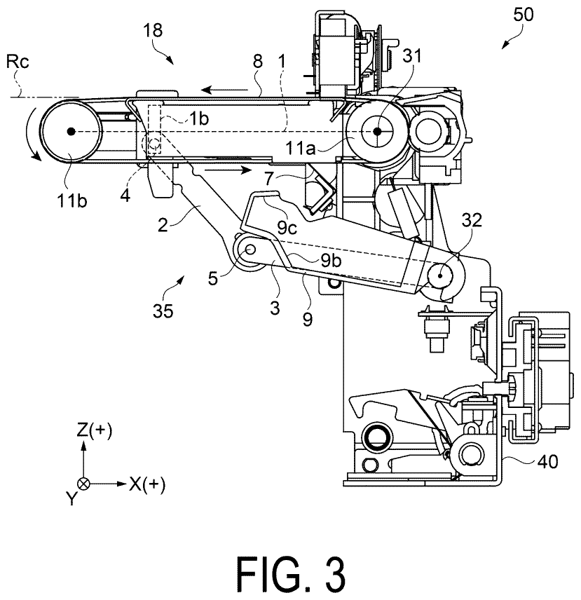

The conveyance unit 18 is provided to be rotatable around the roller 11a by approximately 90 degrees using a link mechanism 35 (FIG. 3) to be described later. In detail, the conveyance unit 18 is provided to be movable to the opposing position shown by a solid line in FIG. 1 and a retracted position shown by an alternating two dots-dashed line. The conveyance unit 18 is a part of the medium conveyance device 50 that includes the link mechanism 35, and details of the medium conveyance device 50 will be described later. In other words, the conveyance unit 18 includes the conveying belt 8 that conveys the medium S serving as a target recording medium at the opposing position facing the liquid ejection unit 13 serving as a recording unit that performs recording. In addition, the posture of the conveying belt 8 at the opposing position is different from the posture of the conveying belt 8 at the retracted position.

The maintenance unit 21 performs maintenance on the liquid ejection unit 13 while the conveyance unit 18 is moved to the retracted position. The maintenance unit 21 includes a cap 22 and a wiping portion 60, and performs maintenance operations such as flushing, capping, suction cleaning, and wiping to prevent or eliminate ejection problems that occur in the liquid ejection unit 13.

FIG. 2 is a plan view seen through the liquid ejection unit 13 from the +Z direction in a state where the conveyance unit 18 is moved to the retracted position, and also shows the maintenance unit 21.

As shown in FIG. 2, the liquid ejection unit 13 includes a plurality of nozzles 12 that eject a liquid, and an opening surface 13a in which the nozzles 12 open. The liquid ejection unit 13 is a line head of which the longitudinal direction is the Y-axis direction, which is the width direction of the conveyance path Rc, and the plurality of nozzles 12 form a plurality of nozzle rows that are oblique to the X-axis direction.

As shown in FIG. 1, when flushing is performed, a cap 22 of the maintenance unit 21 moves from a standby position to directly below the liquid ejection unit 13, as shown by an arrow. A waste liquid discharged from the nozzles 12 by flushing is stored in a waste liquid container 29 via a suction tube 23. When flushing is not performed, the nozzles 12 are capped to prevent the nozzles 12 from drying out. In addition, the inside of the nozzle 12 is suctioned by negative pressure by driving a suction pump 24 in a capped state, and suction cleaning can be performed to discharge foreign matter such as air bubbles along with the liquid.

As shown in FIG. 2, the wiping portion 60 includes a wiping member 61 capable of wiping the liquid ejection unit 13, a liquid receiving portion 62 surrounding the wiping member 61, a moving body 63 that holds and moves the wiping member 61 and the liquid receiving portion 62, a guide shaft 43 which is a screw shaft, and the like.

When wiping is performed, the moving body 63 is moved forward in the Y direction by rotating the guide shaft 43, and the wiping member 61 is brought into sliding contact with the liquid ejection unit 13 to wipe away a liquid adhering to the liquid ejection unit 13.

### Configuration of Conveyance Unit

FIG. 3 is a side cross-sectional view of main parts in one aspect of the medium conveyance device and shows a state where the conveyance unit 18 is located at the opposing position.

As shown in FIG. 3, the medium conveyance device 50 includes a base portion 40, a conveyance unit 18, a link mechanism 35, and the like.

The base portion 40 is a base portion that supports the conveyance unit 18 so that it can rotate between the opposing position and the retracted position. The base portion 40 is provided with two support shafts 31 and 32 that support the conveyance unit 18 including the link mechanism 35. The support shaft 31 is a support shaft that extends in the Y direction and is also the rotation shaft of the roller 11a of the conveyance unit 18. The support shaft 32 is a support shaft similar to the support shaft 31 and is provided below the support shaft 31.

As shown in FIG. 3, at the opposing position, the conveyance unit 18 is in a substantially horizontal state in the-X direction from the roller 11a centered on the support shaft 31. The rollers 11a and 11b are supported and coupled by a first link 1. In FIG. 3, the first link 1 is shown by a schematic dotted line, but actually, the first link 1 is configured with a sturdy metal frame. An elongated hole 1b is provided on the roller 11b side of the first link 1 in a direction perpendicular to the first link 1. In FIG. 3, the longitudinal direction of the elongated hole 1b is the Z direction.

In a preferred example, the conveying belt 8 is an endless belt having electrostatic adsorption properties, and is stretched between the rollers 11a and 11b. The conveyance unit 18 including the conveying belt 8 is provided using the first link 1 as the framework so as to be rotatable around the support shaft 31 as the center of rotation.

The link mechanism 35 includes the first link 1 coupled to the support shaft 31, a third link 3 coupled to the support shaft 32, a second link 2 coupling the first link 1 and the third link 3, and the like. The first link 1 and the second link 2 are coupled by a joint 4. The joint 4 is formed by fitting an engagement pin at one end of the second link 2 into the elongated hole 1b of the first link 1. By configuring the joint 4 to be movable within the elongated hole 1b, distortion during posture changes is absorbed, which enables smooth posture changes.

The other end of the second link 2 and one end of the third link 3 are coupled by a joint 5, which is a rotary joint. The other end of the third link 3 is coupled to the support shaft 32.

With such a configuration, the first link 1, the second link 2, the third link 3, and a line segment coupling the support shaft 31 and the support shaft 32 form a rectangle, and this rectangle functions as a pantograph. In other words, the link mechanism 35 functions as a pantograph to change the posture of the conveyance unit 18. In other words, the conveying belt 8 is configured to be movable between an opposing position and a retracted position which is a position different from the opposing position.

As shown in FIG. 3, a blade 7 is provided as a cleaning unit below the conveying belt 8. The blade 7 is a spatula made of an elastic material such as elastomer, and comes into contact with the conveying belt 8 to remove foreign matter such as paper dust adhering to the belt. The blade 7 is disposed at an angle against the moving direction of the conveying belt 8. In other words, the blade 7 as a cleaning unit cleans the conveying belt 8 by coming into contact with the conveying belt 8 at the opposing position.

A collection unit 9 is provided below the blade 7. The collection unit 9 is a collection box that collects foreign matter removed by the blade 7, and includes a storage chamber 9b that opens upward. A dead-end portion is provided at the end of the storage chamber 9b on the-X side, and a wall above this portion is referred to as a regulating wall 9c. The collection unit 9 is provided integrally along the third link 3, and changes its posture in association with a change in the posture of the third link 3.

In other words, the collection unit 9 is disposed vertically below the blade 7 as a cleaning unit, and collects foreign matter that has fallen off the conveying belt 8. The collection unit 9 is disposed vertically below the conveying belt 8 at the opposing position, is capable of collecting foreign matter that has fallen off the conveying belt 8, and moves in association with the movement of the conveying belt 8.

### Aspect of Change in Posture of Conveyance Unit

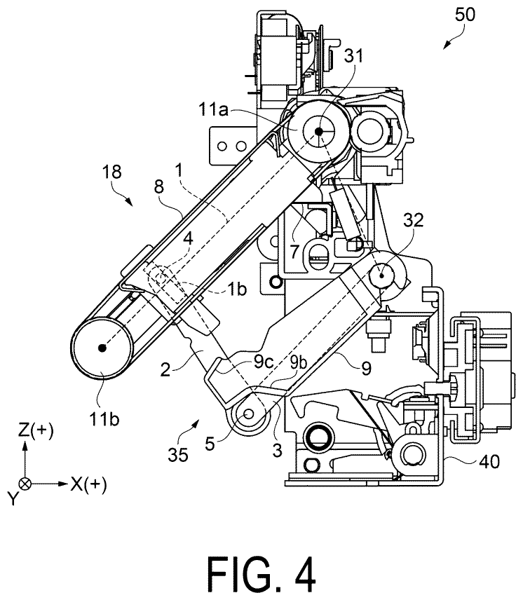

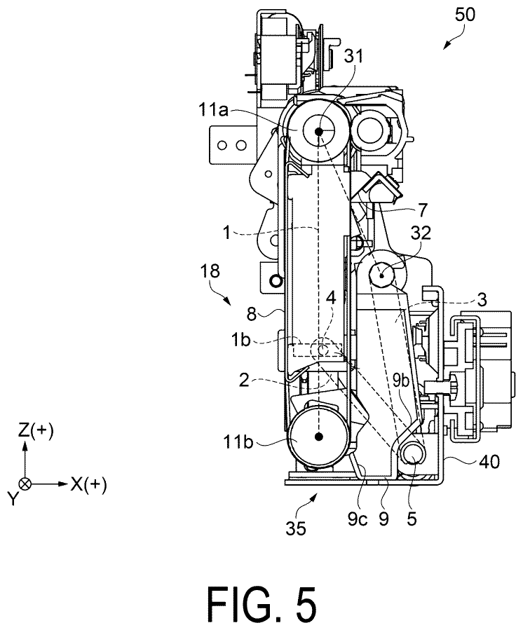

FIG. 4 is a side cross-sectional view of main parts in one aspect of the medium conveyance device, and shows a state where the conveyance unit 18 is moving to the retracted position. FIG. 5 is a side cross-sectional view of main parts in one aspect of the medium conveyance device, and shows a state where the conveyance unit 18 is located at the retracted position.

When the conveyance unit 18 moves from the opposing position to the retracted position, driving is performed such that the position of the joint 5 moves downward. As shown in FIG. 4, when the position of the joint 5 moves downward, the second link 2 pulls down the roller 11b side of the first link 1, and the angle of the first link 1 is inclined at approximately 45 degrees with respect to the X direction. At this time, the first link 1 and the third link 3 are substantially parallel to each other, and the first link 1, the second link 2, and the third link 3, and the line segment coupling the support shaft 31 and the support shaft 32 form substantially a parallelogram. In other words, the link mechanism 35 functions as a pantograph to change the posture of the conveyance unit 18.

At this time, the collection unit 9 is located below the conveying belt 8, and even when foreign matter falls from the conveying belt 8, the collection unit 9 can collect the foreign matter. Furthermore, since the dead-end portion of the storage chamber 9b is located below and the regulating wall 9c is raised, foreign matter inside the storage chamber 9b will not escape to the outside.

Furthermore, when driving is performed such that the position of the joint 5 moves downward, the first link 1 is erected, and the conveyance unit 18 becomes substantially vertical and is stored in the base portion 40, as shown in FIG. 5. At this time, the third link 3 is stored in a substantially erected state in the +X direction of the conveyance unit 18. In other words, the pantograph of the link mechanism 35 is folded and stored in the base portion 40.

At this time, the collection unit 9 is positioned next to the conveying belt 8 in an erected state, but the dead-end portion of the storage chamber 9b serves as at the lowermost portion, and thus the erected regulating wall 9c prevents foreign matter in the storage chamber 9b from escaping to the outside.

In other words, the link mechanism 35 including the first link 1 and the third link 3 plays a role in coupling the conveyance unit 18 and the collection unit 9 when its posture changes, and the posture of the collection unit 9 changes due to the link mechanism 35 when the collection unit 9 moves in association with the movement of the conveying belt 8. The collection unit 9 also includes the storage chamber 9b capable of storing foreign matter, and the regulating wall 9c for regulating falling-off of the foreign matter in the storage chamber 9b when the conveying belt 8 is located at the retracted position.

As shown in FIG. 5, the blade 7 maintains a state of abutting on the conveying belt 8 even at the retracted position. The same applies to the moving state in FIG. 4. In other words, the blade 7 serving as a cleaning unit moves in association with the movement of the conveying belt 8.

### Modification Example

In the above, the conveyance unit 18 has been described as rotating approximately 90 degrees around the support shaft 31, but this is not limited thereto, and it is sufficient that the conveyance unit 18 move to a retracted position where the maintenance unit 21 can move to an opposing position during a maintenance operation. For example, in FIG. 1, the conveyance unit 18 may move horizontally in the +X direction, or may move diagonally downward in the-Z direction and the +X direction. In this case, a movement mechanism for moving the conveying belt 8 horizontally or in parallel may be provided instead of the link mechanism 35. In addition, in this case, the posture of the conveying belt 8, the posture of the collection unit 9, and the posture of the blade 7 may not change in association with the movement of the conveying belt 8.

Furthermore, although the collection unit 9 has been described above as being configured integrally with the third link 3, this is not limited thereto, and for example, the collection unit 9 may be configured to be detachable. Accordingly, the collection unit 9 can be removed to efficiently discard collected foreign matter such as paper dust. In addition, a configuration not including the blade 7 may be adopted. The above-mentioned examples and the following modification examples may be combined for implementation insofar as they are not technically inconsistent.

As described above, according to the medium conveyance device 50 and the recording device 100 of present embodiment, it is possible to obtain the following effects.

The medium conveyance device 50 includes the conveyance unit 18 including the conveying belt 8 that conveys the medium S serving as a target recording medium at an opposing position facing the liquid ejection unit 13 serving as a recording unit that performs recording, and the collection unit 9 that is disposed vertically below the conveying belt 8 located at the opposing position, is configured to collect foreign matter that has fallen off the conveying belt 8, and moves in association with the movement of the conveying belt 8, the conveying belt 8 is configured to be movable between the opposing position and a retracted position that is a position different from the opposing position, and the collection unit 9 moves in association with the movement of the conveying belt 8.

Accordingly, even when the conveying belt 8 is configured to be movable, the collection unit 9 can be provided in a region where the conveying belt 8 moves without impeding the movement of the conveying belt 8, and thus foreign matter can be efficiently collected without scattering.

Thus, it is possible to provide the medium conveyance device 50 that can efficiently collect foreign matter in a configuration in which the conveying belt 8 is movable.

In addition, the medium conveyance device 50 further includes the link mechanism 35 that couples the conveyance unit 18 and the collection unit 9, and the collection unit 9 changes its posture by the link mechanism 35 when moving in association with the movement of the conveying belt 8.

Accordingly, the posture of the collection unit 9 changes in association with the movement of the conveying belt 8 the link mechanism 35, making it possible to reduce a retraction space.

In addition, the posture of the conveying belt 8 at the opposing position is different from the posture of the conveying belt 8 at the retracted position.

Accordingly, the collection unit 9 also follows the movement of the conveying belt 8, making it possible to reduce a retraction space.

In addition, the medium conveyance device 50 further includes the link mechanism 35 that couples the conveyance unit 18 and the collection unit 9, and the collection unit 9 changes its posture by the link mechanism 35 when moving in association with the movement of the conveying belt 8.

Accordingly, the pantograph function of the link mechanism 35 allows the collection unit 9 to be folded in response to the movement of the conveying belt 8, making it possible to reduce a retraction space.

The medium conveyance device 50 further includes the blade 7 serving as a cleaning unit that comes into contact with the conveying belt 8 located at the opposing position to clean the conveying belt 8, and the collection unit 9 is disposed vertically below the blade 7 serving as a cleaning unit.

Accordingly, it is possible to allow foreign matter adhering to the conveying belt 8 to efficiently fall off the conveying belt 8.

Furthermore, the blade 7 serving as a cleaning unit moves in association with the movement of the conveying belt 8. Accordingly, the blade 7 does not interfere with the movement of the conveying belt 8.

The collection unit 9 is also configured to be removable.

Accordingly, the collection unit 9 can be removed to efficiently discard collected foreign matter such as paper dust.

The collection unit 9 also includes the storage chamber 9b capable of storing foreign matter, and the regulating wall 9c for regulating falling-off of the foreign matter in the storage chamber 9b when the conveying belt 8 is located at the retracted position.

Accordingly, even when the posture of the conveying belt 8 changes due to movement, it is possible to prevent foreign matter from falling off the collection unit 9.

The recording device 100 includes the liquid ejection unit 13 serving as a recording unit that performs recording on the medium S serving as a target recording medium, and the medium conveyance device 50 including the conveyance unit 18.

Accordingly, the recording device 100 includes the medium conveyance device 50 described above.

Thus, it is possible to provide the recording device 100 that is capable of efficiently collecting foreign matter in a configuration in which the conveying belt 8 is movable.

What is claimed is:

1. A medium conveyance device comprising:
a conveyance unit that includes a conveying belt that is configured to convey a target recording medium at an opposing position facing a recording unit that is configured to perform recording; and
a collection unit that is disposed vertically below the conveying belt at the opposing position and is configured to collect foreign matter that has fallen off the conveying belt,
wherein the conveying belt is configured to be movable between the opposing position and a retracted position that is a position different from the opposing position, and
the collection unit moves in association with a movement of the conveying belt.

2. The medium conveyance device according to claim 1, further comprising a link mechanism that is configured to couple the conveyance unit and the collection unit,
wherein the collection unit changes its posture due to the link mechanism when moving in association with the movement of the conveying belt.

3. The medium conveyance device according to claim 1, wherein the posture of the conveying belt at the opposing position is different from the posture of the conveying belt at the retracted position.

4. The medium conveyance device according to claim 3, further comprising a link mechanism that is configured to couple the conveyance unit and the collection unit,
wherein the collection unit changes its posture due to the link mechanism when moving in association with the movement of the conveying belt.

5. The medium conveyance device according to claim 1, further comprising a cleaning unit that is configured to come into contact with the conveying belt located at the opposing position to clean the conveying belt,
wherein the collection unit is disposed vertically below the cleaning unit.

6. The medium conveyance device according to claim 5, wherein the cleaning unit moves in association with the movement of the conveying belt.

7. The medium conveyance device according to claim 1, wherein the collection unit is configured to be removable.

8. The medium conveyance device according to claim 2, wherein the collection unit includes a storage chamber that is configured to store the foreign matter, and includes a regulating wall that regulates falling-off of the foreign matter in the storage chamber when the conveying belt is located at the retracted position.

9. A recording device comprising:
a recording unit that is configured to perform recording on a target recording medium, and
the medium conveyance device according to claim 1.

10. A recording device comprising:
a recording unit that is configured to perform recording on a target recording medium, and
the medium conveyance device according to claim 8.
